(19) United States
(12) Patent Application Publication
(10) Pub. No.: US 2008/0131805 A1
(43) Pub. Date: Jun. 5, 2008

(54) Two-component developer, developing device using two-component developer, and image forming apparatus

(75) Inventors: Hideaki Kawata, Osaka-shi (JP); Takeo Mizobe, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/998,233

(22) Filed: Nov. 29, 2007

(30) Foreign Application Priority Data
Nov. 30, 2006 (JP) 2006-324342
May 16, 2007 (JP) 2007-130738

(51) Int. Cl. G03G 9/083; G03G 15/09

(52) U.S. Cl. 430/110.3; 399/274

(57) ABSTRACT

A two-component developer is provided with cylindrical toner particles and magnetic carrier particles having an average sphericity of 0.95 or more. When such a developer is used in development using a two-component developing method, a clear image can be stably obtained for a long period by suppressing a spent phenomenon and an insufficiency of cleaning.

### BACKGROUND OF THE INVENTION

1. Field of the Invention

The present invention relates to a two-component developer, a developing device using the two-component developer, and an image forming apparatus.

2. Description of the Related Art

A method of developing an electrostatic latent image formed on the surface of a photoconductor in electrophotographic image formation includes, for example, a monocomponent developing method using a monocomponent developer made of only toner particles and a two-component developing method using a two-component developer containing toner particles and magnetic carrier particles.

An image forming apparatus 200 using a usual two-component developing method will now be described by way of FIG. 6.

Referred to FIG. 6, first, the surface of a drum-shaped photoconductor 120 is uniformly charged to a predetermined polarity by a charger 121 and light is irradiated on the charged surface of the photoconductor 120 using an exposure device 122 to form an electrostatic latent image. A developing roller 131 mounted in a developing device 123 is arranged around the photoconductor 120 so as to face therewith.

The developing roller 131 includes a number of magnets having a magnetic pole installed therein and a two-component developer t encased in the developer tank 130 adheres to the peripheral surface of the developing roller 131 in the form of a magnetic brush. Also, in the developing roller 131, a layer thickness regulating member 132, which regulates the layer thickness of the two-component developer t and charges toner particles, is disposed while maintaining a fixed gap with the surface of the developing roller 131. Then, toner particles are charged by friction between toner particles and magnetic carrier particles, which constitute a two-component developer t, when the two-component developer t passes through the layer thickness regulating member 132. Then, a toner image is formed by adhering only toner particles onto the surface of the photoconductor 120 when the magnetic brush-shaped two-component developer t on the peripheral surface of the developing roller 131 is brought into contact with the surface of the photoconductor 120 on which an electrostatic latent image is formed. The toner particles left on the surface of the photoconductor drum 120 after formation of the toner image are recovered by scraping using a cleaning blade 125A of a cleaning device 125 in contact with the surface of the photoconductor 120. The toner image is transferred onto a paper 119 conveyed to a transfer device 124 by conveying means 128 and then fixed by heating under pressure using a fixing device 129 to form an image.

In the image forming apparatus using a two-component developing method, a two-component developer to be stirred in a developing device preferably has high fluidity so as to stably form a clear image for a long period.

Toner particles, which have heretofore been used widely, have been produced using a grinding method or a polymerization method. The toner particles to be obtained by a grinding method are obtained by adding a colorant, a charge control agent and a releasant to a thermoplastic resin, followed by melt-kneading, grinding and further classification. The toner particles obtained by the grinding method have a drawback such as poor fluidity because they have a distorted particle form. Also, the entire surface of the toner particles is a crushed surface and therefore a wax and a low melting point component are likely to be exposed on the surface, and thus there may arise a so-called spent phenomenon in which the toner particles are pressed against the surface of magnetic carrier particles and adhered thereon.

Also, spherical toner particles obtained by a polymerization method are used so as to solve the above problems. When spherical toner particles are used, fluidity is improved.

However, there is a problem that, when spherical toner particles are used, toner particles left on the surface of the photoconductor after development, sometimes escape through a gap between the cleaning blade 125A and the photoconductor 120 without being trapped sufficiently by the cleaning blade 125A in the case of scraping using the cleaning blade 125A, and thus cleaning properties deteriorate. When cleaning properties are insufficient, there may come in a so-called fog phenomenon in which the toner is deposited on the non-imaged area which should serve as a blank through the developing operation, and thus the fog density increases.

Also, a method of employing magnetic carrier particles having high sphericity is used in place of spherical toner particles so as to improve fluidity.

However, when magnetic carrier particles having high sphericity are used, the apparent density of the resulting two-component developer increases. In this case, when the two-component developer adhered onto the surface of the developing roller 131 passes through the layer thickness regulating member 132, a high mechanical load is applied between toner particles and magnetic carrier particles, and thus there may arise a so-called spent phenomenon in which the toner particles are pressed against the surface of magnetic carrier particles and adhered thereon.

As described above, there has never been obtained a two-component developer capable of suppressing a spent phenomenon and an insufficiency of cleaning while maintaining fluidity.

### SUMMARY OF THE INVENTION

An object of the present invention is to provide a two-component developer which has good fluidity and can suppress a spent phenomenon and an insufficiency of cleaning.

One aspect of the present invention pertains to a two-component developer comprising cylindrical toner particles, and magnetic carrier particles having an average sphericity of 0.95 or more.

Objects, features, aspects and advantages of the present invention become more apparent from the following detailed description and accompanying drawings.

### BRIEF DESCRIPTION OF THE DRAWINGS

FIG. 1 is a schematic view showing a constitution of an image forming apparatus used in one embodiment of the present invention.

FIG. 2A is a schematic perspective view of cylindrical toner particle of one embodiment according to the present invention.

FIG. 2B is a schematic top view of cylindrical toner particle of one embodiment according to the present invention.

FIG. 2C is a schematic side view of cylindrical toner particle of one embodiment according to the present invention.

FIG. 3 is a schematic explanatory view for explaining a kneading step and a fiberizing step in the production of cylindrical toner particles.

FIG. 4 is a schematic explanatory view for explaining a cutting step in the production of cylindrical toner particles.

FIG. 5 is a schematic view showing an image forming unit employing a touchdown developing method.

FIG. 6 is a schematic view showing a constitution of a conversional image forming apparatus.

### DETAILED DESCRIPTION OF THE INVENTION

Embodiments of the present invention will now be described in detail with reference to the accompanying drawings. However, the present invention is not limited by these embodiments.

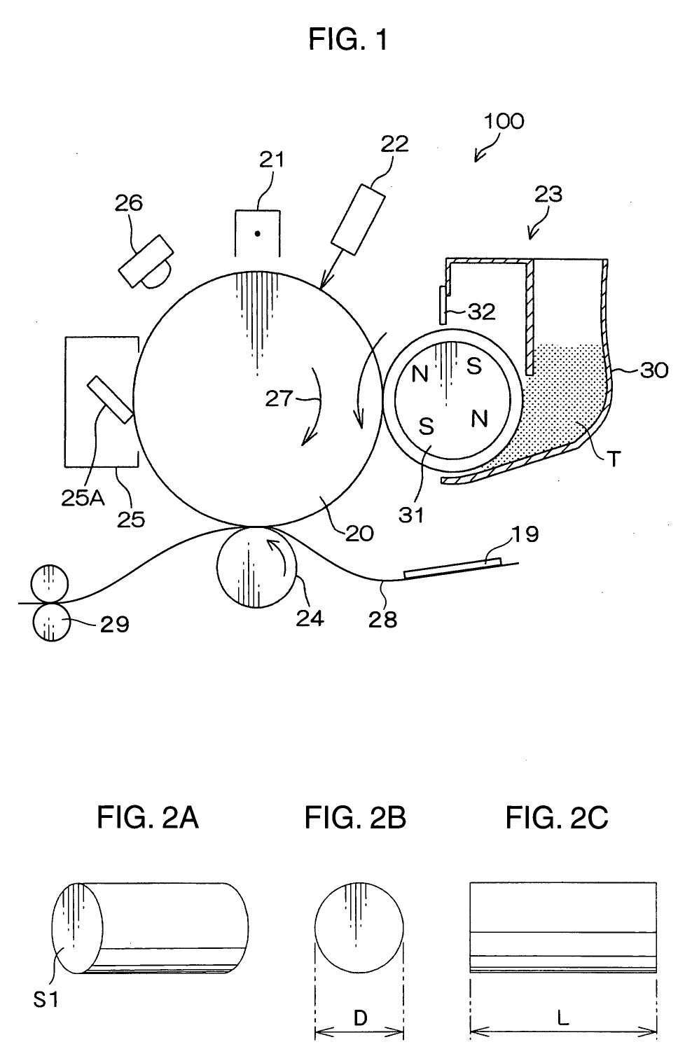

FIG. 1 is a schematic view showing a constitution of an image forming apparatus 100 in which an image is formed using a two-component developer according to one embodiment of the present invention.

Referring to FIG. 1, the image forming apparatus 100 includes a charger 21 for charging the surface of a photoconductor 20, an exposure device 22 for exposing the surface of the photoconductor 20 charged with the charger 21, a developing device 23 for supplying a two-component developer to the photoconductor 20 on which an electrostatic latent image is formed by exposure, a transfer device 24 for transferring a toner image formed on the surface of the photoconductor 20 onto a paper 19, a cleaning device 25 equipped with a cleaning blade 25A for removing the toner particles left on the surface of the photoconductor 20 after transferring the toner image onto the paper 19, and a discharging device 26 for discharging the surface of the photoconductor 20. The charger 21, the exposure device 22, the developing device 23, the transfer device 24, the cleaning device 25 and the discharging device 26 are sequentially arranged along a rotation direction (direction indicated by arrow 27) of the photoconductor 20.

The developing device 23 includes a developer tank 30 which encases a two-component developer T, a cylindrical developing roller 31 which is disposed in the developing device 23 and supports the two-component developer on the peripheral surface of the developing roller 31 while rotating to direction indicated by arrow, and a layer thickness regulating member 32 which is disposed on the peripheral surface of the developing roller 31 while maintaining a fixed gap. The developing roller 31 includes a number of magnets having a magnetic pole installed therein and the two-component developer encased in the developer tank 30 is supported on the peripheral surface of the developing roller 31 in the form of a magnetic brush. The layer thickness of the two-component developer supported in the form of a magnetic brush is regulated in the case of passing through a gap between the developing roller 31 and the layer thickness regulating member 32, and toner particles are charged by friction between toner particles and magnetic carrier particles.

As the material of the layer thickness regulating member 32, for example, a metallic blade made of stainless steel or copper, and a ceramic blade made of aluminum oxide are used.

The electrostatic latent image to be formed on the surface of the photoconductor 20 is formed by uniformly charging the surface of the photoconductor 20 to a predetermined polarity and exposing the charged surface of the photoconductor 20 corresponding to image data using the exposure device 22.

Then, when the two-component developer supported on the peripheral surface of the developing roller 31 is brought into contact with the surface of the photoconductor 20, only toner particles adhere onto the surface of the photoconductor 20 to form a toner image. Consequently, the electrostatic latent image formed on the photoconductor 20 is developed. The resulting toner image is transferred onto the paper 19 conveyed from conveying means 28 by the transfer device 24, conveyed to a fixing device 29, and then fixed by heating under pressure to form an image.

The magnetic carrier particles supported on the peripheral surface of the developing roller 31 are not consumed by development and are recovered to the developer tank 30 as they are, and then used after mixing again with toner particles. Also, toner particles left on the surface of the photoconductor 20 after transferring the toner image is recovered by scraping using a cleaning blade 25A in contact with the peripheral surface of the photoconductor 20.

A two-component developer of the present embodiment will now be described.

The two-component developer of the present embodiment is a two-component developer including cylindrical toner particles, and magnetic carrier particles having an average sphericity of 0.95 or more.

FIG. 2A to FIG. 2C are schematic views of cylindrical toner particles, FIG. 2A is a perspective view, FIG. 2B is an end view, and FIG. 2C is a side view, respectively. As shown in FIG. 2A to FIG. 2C, when the toner particles are cylindrical, in the case of scraping the residual toner particles on the surface of a photoconductor using a cleaning blade after transferring a toner image, the boundary between a cylindrical side face and the cylindrical bottom face forms an edge, and thus toner particles themselves exert an action of scraping the residual toner particles by the edge. Furthermore, it becomes difficult for cylindrical toner particles to pass through the cleaning blade because the edge exerts an action of hooking, and thus excellent cleaning properties are obtained. In a developing device, toner particles are likely to roll because the toner particles are cylindrical, and thus fluidity of the developer can be maintained. Furthermore, since the toner particles roll when a two-component developer adhered onto the surface of a developing roller passes through a layer thickness regulating member, the mechanical load to be applied to the toner particles and magnetic carrier particles decreases and the occurrence of a spent phenomenon is suppressed.

As described in detail in Japanese Unexamined Patent Publication (Kokai) No. 2006-106236, the cylindrical toner particles 13 are obtained by melt-kneading a toner material, forming a molten toner material into a fiber, and cutting the fiber made of the toner material, so called melt-blown method.

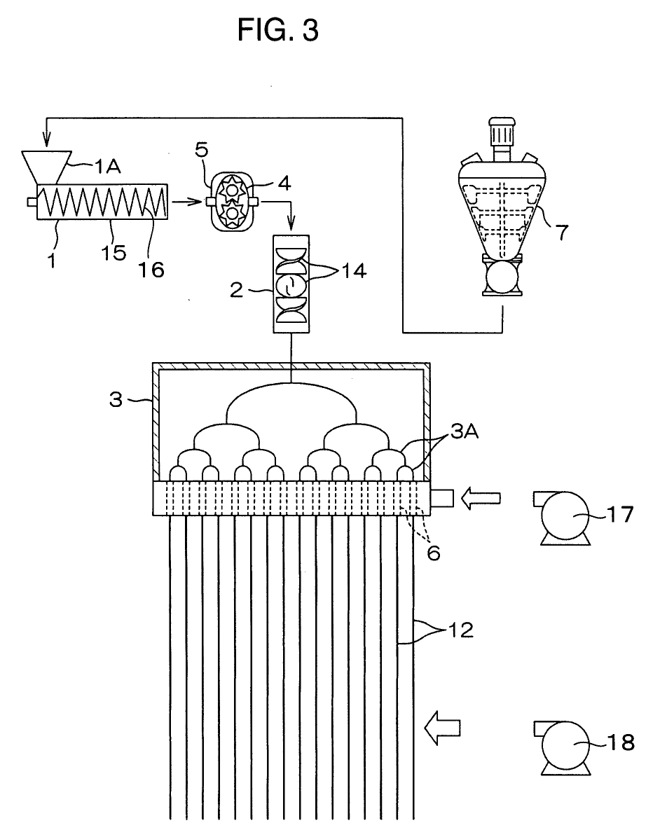

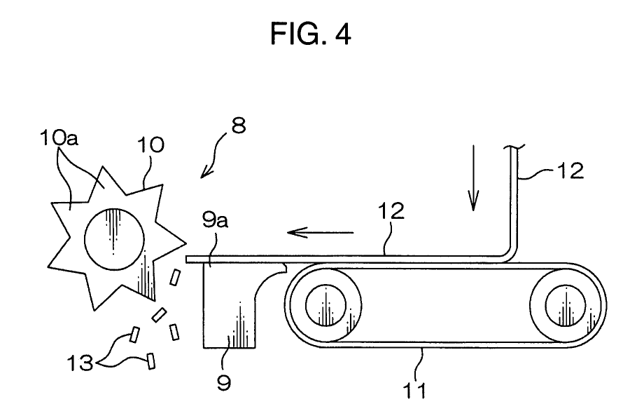

A method for producing the cylindrical toner particles will now be described in detail with reference to FIG. 3 and FIG. 4.

First, as shown in FIG. 3, a toner material is melt-kneaded in an extruder 1.

The toner material in the present embodiment contains a binder resin, a colorant, a charge control agent and a releasant, which are as described hereinafter. Specifically, the toner material is composed of 80 to 93% by mass of a binder resin, 3 to 8% by mass of a releasant (wax), 3 to 8% by mass of a pigment (colorant) and 1 to 3% by mass of a charge control agent. These respective components are supplied to a premixing device (for example, Cyclomix manufactured by Hosokawa Micron Corporation) 7 and, after premixing, the premix is supplied to the extruder 1 through a hopper 1A. The extruder 1 is equipped with a cylinder 15 with a heater, and is also equipped with a rotary screw 16 for melt-kneading the toner material in the cylinder 15. The respective components supplied to the extruder 1 are melt-kneaded at a predetermined kneading temperature (for example, 140° C.) using the rotary screw 16. The extruder 1 is equipped with a gear pump 4 which adjusts the discharge amount of the molten toner at a discharge port and which is driven by a motor 5. The molten toner material is transferred to a static mixer 2 connected to the gear pump 4.

In the static mixer 2, multiple blades 14 composed of a twisted curved surface are disposed and a spiral flow passage is formed by the blades 14. The molten toner material transferred from the extruder 1 is further melt-kneaded by rotation of the blades 14 and the respective components constituting the toner material are dispersed uniformly and finely. In the static mixer 2, the molten toner material is maintained at a temperature which is higher than the kneading temperature of the extruder (for example, 180° C.).

To the static mixer 2, a flow passage structure 3 including a multi-stage distributed flow passage 3A is connected. The molten toner material is supplied to the distributed flow passage 3A from the staticmixer 2, heated to a higher temperature (for example, 215° C.) by a heater (not shown) disposed in the flow passage structure 3, and then extruded into a fiber through nozzles 6 provided at flow passage outlets of the respective distributed flow passages 3A. For example, the inner diameter of the discharge ports of the nozzles 6 is set to 5 μm.

The fiber-like molten toner material extruded through the nozzles 6 is drawn by hot air at about 215° C. blown from a hot air blowing device 17 and then quickly cooled by cold air blown from a cold air blowing device 18 to form a fiber-like toner 12.

A cutting step of cutting the fiber-like toner 12 thus formed will now be described.

As shown in FIG. 4, the fiber-like toner 12 thus formed is conveyed to a cutting device 8 as is using a conveying device 11. The cutting device 8 is equipped with a stationary knife 9 extending in a direction intersecting perpendicularly to a conveying direction of the fiber-like toner 12 to be conveyed on the conveying device 11, and a rotary knife 10 which is rotation-driven by a motor (not shown) The fiber-like toner 12 is continuously supplied between the stationary knife 9 and the rotary knife 10. Then, the fiber-like toner 12 is sequentially cut by a shearing action produced between an edge 9a of the stationary knife 9 and a cutter blade 10a of the rotary knife 10 to continuously produce cylindrical toner particles 13.

The length L of the cylindrical toner particles 13 can be adjusted by the ratio of the conveying speed of the fiber-like toner 12 to the rotary speed of the rotary knife 10. Also, the diameter D of the cylindrical toner particles 13 can be adjusted by the inner diameter of the discharge ports of the nozzles 6.

In such a manner, cylindrical toner particles 13 having the length L (μm) and the diameter D (μm) as shown in FIG. 2A to FIG. 2C are obtained.

The cylindrical diameter D of the cylindrical toner particles 13 is preferably within a range from 5 to 10 μm, and more preferably from about 4 to 9 μm because adhesionon to the carrier can be suppressed.

The length L of the cylindrical toner particles 13 is preferably from 4 to 13 μm, and more preferably from about 4 to 9 μm because the cylindrical toner particles are easily separated from the carrier.

L/D of the cylindrical toner particles 13 is preferably within a range from 1 to 2.

When L/D is less than 1, the proportion of a cut surface S1 based on the entire external surface of cylindrical toner particles increases. Since a comparatively large amount of the wax is exposed on the cut surface and the surface is distorted, the effect of suppressing the spent phenomenon may decrease. When L/D is more than 2, fluidity deteriorates and also becomes difficult to separate from the carrier.

L/D can be easily adjusted by adjusting the diameter of the discharge port of the nozzles 6 or adjusting the conveying speed of the fiber-like toner 12 and the rotary speed of the rotary knife 10.

The cylindrical toner particles 13 thus formed may be further subjected to a surface treatment using colloidal silica or hydrophobic silica.

It is preferred to externally add an external additive to the cylindrical toner particles 13 using a Henschel mixer (manufactured by Mitsui Mining Co., Ltd.).

The external additive is a component to be added so as to improve fluidity of the two-component developer. It is possible to use conventionally known external additives, for example, silica, alumina, tin oxide, titanium oxide, strontium oxide and various resin powders, each having a particle size within a range from about tens of nanometers to about hundreds of nanometers, without any restriction. It is more preferred that the external additives are subjected to a surface treatment using a silane coupling agent.

The amount of the external additive to be added is preferably from 0.1 to 5 parts by mass, and more preferably from 0.5 to 3 parts by mass, based on 100 parts by mass of the cylindrical toner particles. When the amount of the external additive is too small, fluidity may decreases and frictional electrification with the carrier may be insufficient, and thus developability may deteriorate and image density (ID) may decrease. In contrast, when the amount of the external additive is too large, falling of the external additive from the toner surface may occur, and also charging of the toner may become unstable because adhesion onto the surface of the carrier often occur and thus fog density (FD) may increase.

Constituent components of the toner material will now be described in detail.

It is possible to use, as the binder resin constituting the toner material, those which have conventionally been used as a binder resin for a toner without any restriction. For example, thermoplastic resins such as a polystyrene-based resin, a styrene-acrylic-based copolymer, an acrylic-based resin, a polyester-based resin, a polyethylene-based resin, a polypropylene-based resin, a vinyl chloride-based resin, a polyamide-based resin, a polyurethane-based resin, a polyvinyl alcohol-based resin, a vinylether-based resin, a N-vinyl-based resin and a styrene-butadiene-based resin are preferably used.

The polystyrene-based resin includes, in addition to a styrene homopolymer, a copolymer of styrene and a monomer which is copolymerizable with styrene. Examples of the monomer which is copolymerizable with styrene include p-chlorostyrene; vinyl naphthalene; unsaturated monoolefins such as ethylene, propylene, butylene and isobutylene; vinyl halides such as vinyl chloride, vinyl bromide and vinyl fluoride; vinyl esters such as vinyl acetate, vinyl propionate, vinyl benzoate and vinyl butyrate; (meth) acrylate esters such as methyl acrylate, ethyl acrylate, n-butyl acrylate, isobutyl acrylate, dodecyl acrylate, n-octyl acrylate, 2-chloroethyl acrylate, phenyl acrylate, a-chloromethyl acrylate, methyl methacrylate, ethyl methacrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinylpyrrole, N-vinylcarbazole, N-vinylindole and N-vinyl pyrrolidene. These monomers may be used alone, or two or more kinds of them may be used in combination.

With respect to the molecular weight of the polystyrene-based resin used as the binder resin, it is preferred that the molecular weight distribution has at least two peaks, a peak of comparatively low molecular weight within a range from 3,000 to 20,000 and a peak of comparatively high molecular weight within a range from 300,000 to 1,500,000 and 10 or more of Mw/Mn (mass average molecular weight/number average molecular weight). If the molecular weight distribution of the polystyrene-based resin is within the above range, the toner particles having excellent fixability and anti-offset properties is obtained. The molecular weight distribution can be determined by GPC (gel permeation chromatography). For example, the molecular weight can be determined from a calibration curve which is preliminarily obtained using a standard polystyrene resin after measuring the time of elution from the column of a molecular weight measuring device HLC-8220 manufactured by Tosoh Corporation using THF (tetrahydrofuran) as the solvent.

As the polyester-based resin, for example, those obtained by polycondensation of an alcohol component and a carboxylic acid component are used.

As specific examples of the alcohol component, dihydric alcohols include diols such as ethylene glycol, diethylene glycol, triethylene glycol, 1,2-propyleneglycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol; bisphenols, such as bisphenol A, hydrogenated bisphenol A, polyoxyethylenated bisphenol A and polyoxypropylenated bisphenol A; and tri- or higher polyhydric alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5,-trihydroxymethylbenzene.

As the carboxylic acid component, for example, a di-, tri- or higher polyhydric carboxylic acid, and an acid anhydride and a lower alkyl ester thereof are used. Specific examples of the dihydric carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid or an alkyl- or alkenylsuccinic acid such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid or isododecenylsuccinic acid. Specific examples of the tri- or higher polyhydric carboxylic acid include 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and enpol trimer acid.

The softening point of the polyester-based resin is preferably from 110 to 150° C., and more preferably from 120 to 140° C., in view of excellent fixability.

The binder resin is preferably the above thermoplastic resin in view of good fixability. However, it is not required to use only the thermoplastic resin and a small amount of a crosslinked resin or thermosetting resin, whose gel fraction (the amount of a crosslinked moiety) is within a range from about 0.1 to 10% by mass, may be used. When a small amount of the crosslinked resin or the thermosetting resin having partially a crosslinked structure is used, storage stability and shape retention or durability of the toner can be improved without deteriorating fixability. The gel fraction can be measured using a Soxhlet extractor.

Specific examples of the thermosetting resin include epoxy-based resins such as a bisphenol A type epoxy resin, a hydrogenated bisphenol A type epoxy resin, a novolak type epoxy resin, a polyalkylene ether type epoxy resin and a cyclic aliphatic epoxy resin, and a cyanate-based resin. These thermosetting resins may be used alone, or two or more kinds of them may be used in combination.

The glass transition point (Tg) of the binder resin is preferably from about 50 to 70° C. When the glass transition point of the binder resin is lower than 50° C., the resulting toners may adhere to each other by fusing, thereby deteriorating storage stability. In contrast, when the glass transition point of the binder resin is higher than 70° C., fixability of the toner may become inferior. The glass transition point of the binder resin can be determined from the change point of the specific heat using a differential scanning calorimeter (DSC). For example, the glass transition point can be determined by the following procedure. Namely, 10 mg of a measuring sample is placed in an aluminum pan and measurement is performed at a measuring temperature within a range from 25 to 200° C. and a temperature raising rate of 10° C./min using a differential scanning calorimeter DSC-6200 manufactured by Seiko Instruments Inc. as the measuring device and using a vacant aluminum pan as the reference. The glass transition point can be determined from the change point of the resulting endothermic curve.

It is possible to use, as the releasant (wax) constituting the toner material, those which have conventionally been used as a releasant for a toner without any restriction. Specific examples thereof include vegetable waxes such as carnauba wax, sugarcane wax and Japan wax; animal waxes such as beeswax, insect wax, whale wax and wool wax; and synthetic hydrocarbon-based waxes such as Fischer-Tropsch (hereinafter referred to “FT”) wax having an ester on the side chain, polyethylene wax and polypropylene wax.

Of these releasants, a FT wax having an ester on the side chain and a polyethylene wax are preferably used in view of excellent dispersibility.

The releasant (wax) has a preferably endothermic main peak in the endothermic curve measured by DSC within a range from 70 to 120° C. When the endothermic main peak is lower than 70° C., a blocking phenomenon and a hot-offset phenomenon of the toner may occur. In contrast, when the endothermic main peak is higher than 120° C., fixability at low temperature may deteriorate.

The amount of the releasant (wax) to be added is preferably within a range from 1 to 20 parts by mass based on 100 parts by mass of the binder resin. When the amount is less than 1 part by mass, the addition effect is less likely to be obtained. In contrast, when the amount is more than 20 parts by mass, blocking resistance may deteriorate and also the releasant may fall from the toner.

Specific examples of the colorant constituting the toner material include black pigments, for example, carbon blacks such as acetylene black, lamp black and aniline black; yellow pigments such as Chrome Yellow, Zinc Yellow, Cadmium Yellow, Yellow Iron Oxide, Mineral Fast Yellow, Nickel Titanium Yellow, Nables Yellow, Naphthols Yellow S, Hansa Yellow G, Hansa Yellow 10G, Benzidine Yellow G, Benzidine Yellow GR, Quinoline Yellow Lake, Permanent Yellow NCG and Tartrazine Lake; orange pigments such as Chrome Orange, Molybdenum Orange, Permanent Orange GTR, Pyrazolone Orange, Vulcan Orange, Indathrene Brilliant Orange RK, Benzidine Orange G and Indathrene Brilliant Orange GK; red pigments such as Blood Red, Cadmium Red, Red Lead, Cadmium Mercury Sulfide, Permanent Red 4R, Lithol Red, Pyrazolone Red, Watching Red Calcium Salt, Lake Red D, Brilliant Carmine 6B, Eosine Lake, Rhodamine Lake B, Alizarin Lake and Brilliant Carmine 3B; violet pigments such as Manganese Violet, Fast Violet B and Methyl Violet Lake; blue pigments such as Prussian Blue, Cobalt Blue, Alkali Blue Lake, Victoria Blue Lake, Phthalocyanine Blue, metal-free Phthalocyanine Blue, partially chlorinated Phthalocyanine Blue, Fast Skyblue and Indathrene Blue BC; green pigments such as Chromium Green, Chromium Oxide, Pigment Green B, Malachite Green Lake and Fanal Yellow Green G; white pigments such as zinc white, titanium oxide, antimony white, zinc sulfide, barite powder, barium carbonate, clay, silica, white carbon, talc and alumina white.

The amount of the colorant to be added is preferably from 2 to 20 parts by mass, and more preferably from 3 to 15 parts by mass, based on 100 parts by mass of the binder resin.

It is possible to use, as the charge control agent constituting the toner material, those which have conventionally been used as a charge control agent for a toner without any restriction. Specific examples thereof include charge control agents which exhibit positive chargeability, for example, nigrosin, a quaternary ammonium salt compound and a resin type charge control agent obtained by bonding a resin with an amine-based compound. In the case of a color toner, a colorless or white charge control agent is preferred.

The amount of the charge control agent to be added is preferably from 0.5 to 10 parts by mass, and more preferably from 1 part by mass to 5 parts by mass, based on 100 parts by mass of the binder resin.

To the cylindrical toner particles, various additives such as a surface treating agent, which has conventionally been added to a toner, may be added.

Magnetic carrier particles will now be described.

The magnetic carrier particles used in the present embodiment are magnetic carrier particles having an average sphericity of 0.95 or more. By using magnetic carrier particles having an average sphericity of 0.95 or more, the resulting two-component developer is excellent in fluidity and it is possible to form an image which is stable for a long period. When the average sphericity of the magnetic carrier particles is less than 0.95, the resulting two-component developer is inferior in fluidity and it is impossible to stably form a clear image for a long time.

As the magnetic carrier particles, for example, conventionally known magnetic particles and magnetic resin particles obtained by dispersing magnetic particles in a resin are used without any restriction. Specific examples thereof include particles made of iron, oxidized iron, reduced iron, magnetite, copper, silicon steel, ferrite, nickel and cobalt; particles made of alloys of the above-mentioned metals and manganese, zinc and/or aluminum; and particles made of an iron-nickel alloy and an iron-cobalt alloy; ceramics particles made of titanium oxide, aluminum oxide, copper oxide, magnesium oxide, lead oxide, zirconium oxide, silicon carbide, magnesium titanate, barium titanate, lithium titanate, lead titanate, lead zirconate and lithium niobate; particles of substances having a high dielectric constant such as ammonium dihydrogenphosphate, potassium dihydrogenphosphate and rochelle salt; and resin carriers obtained by dispersing the above-mentioned magnetic particles in a resin.

The magnetic carrier particles are particularly preferably so-called resin coating carrier particles with a resin coat layer formed on the surface. Formation of a resin layer on the surface makes it possible to control the charge amount and polarity of toner particles, to improve humidity dependence and to suppress the occurrence of filming (spent phenomenon).

As the resin coat layer, for example, conventionally known resins for coating carrier are used without any restriction, and specific examples thereof include a (meth)acrylic polymer, a styrene-based polymer, a styrene-(meth)acrylic-based copolymer, an olefinic-based polymer (polyethylene, chlorinated polyethylene, polypropylene, etc.), polyvinyl chloride, polyvinyl acetate, polycarbonate, a cellulose resin, a polyester resin, an unsaturated polyester resin, a polyamide resin, a polyurethane resin, an epoxy resin, a silicone resin, a fluororesin (polytetrafluoroethylene, polychlorotrifluoroethylene, polyvinylidene fluoride, etc.), a phenol resin, a xylene resin, a diallyl phthalate resin, a polyacetal resin and an amino resin. These resins may be used alone or in combination. If necessary, the resin coat layer may contain additives for adjusting characteristics of the resin coat layer, such as silica, alumina, carbon black, a fatty acid metal salt, a silane coupling agent and a titanate coupling agent.

The weight average particle size of the resin coating carrier particles is preferably within a range from 10 to 200 μm, more preferably from 25 to 150 μm, and particularly preferably from 35 to 60 μm.

There are no restrictions on the thickness of the resin coat layer. Specifically, the thickness is adjusted so that the mass of the resin coat layer is preferably from 0.01 to 10% by mass, and more preferably from 0.05 to 5% by mass, based on the mass of the carrier core material.

Intense interest has recently been shown towards a full color image forming apparatus using a touchdown developing method as one of the two-component developing methods.

As a full color image forming apparatus, for example, intense interest has been shown towards a so-called tandem-type apparatus in which plural color image forming units corresponding to each color toner are arranged in an apparatus and color development is performed on a transfer member by synchronizing development using each color image forming unit with feed of the transfer member to form a color image and the color image on the transfer member is transferred to a paper, in view of excellent high-speed formation of an image. This tandem apparatus is excellent in high speed properties, but has a drawback that the apparatus is upsized because plural image forming units must be arranged.

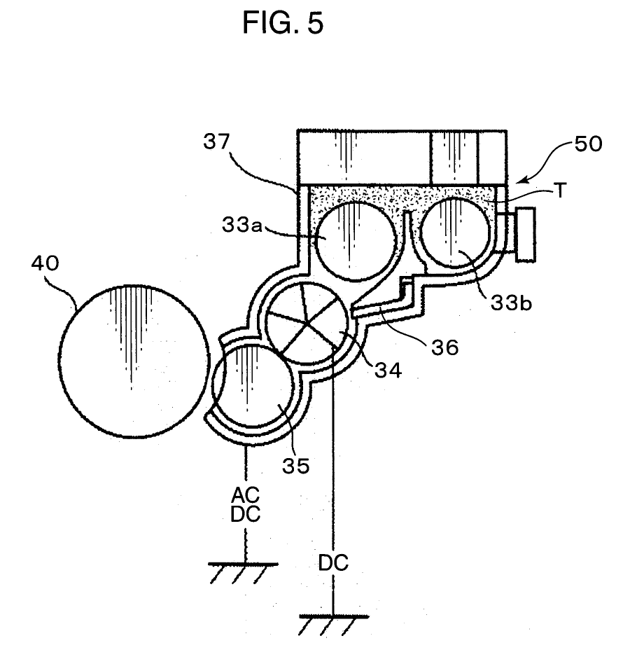

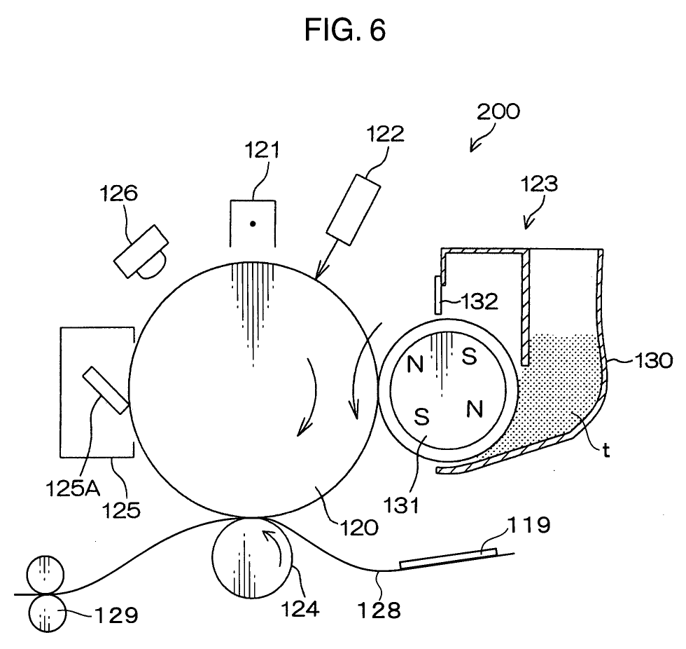

Thus, as a downsized tandem-type apparatus, for example, there is proposed a downsized tandem image forming apparatus which is equipped with plural downsized image forming units so as to decrease the distance between photoconductors. In the downsized tandem apparatus, it is preferred to employ a two-component developing method because it is possible to quickly charge in a desired charge amount by mixing toner particles and magnetic carrier particles with stirring in a developing device, thus making it possible to apply to high density printing and continuous printing. Also, when employing a touchdown developing method as a non-contact developing method in which a gap is maintained between a photoconductor and a developing roller, neither adhesion of carrier particles onto the photoconductor, nor scratching of the photoconductor due to a magnetic brush occurs and thus an image having high image quality can be obtained, preferably. In the downsized tandem image forming apparatus, there is preferably used an image forming unit as shown in FIG. 5 in which a developing device 50 using a vertical touchdown developing method is disposed above a photoconductor 40 so as to downsize the image forming unit.

When the two-component developer of the present embodiment is used in the above touchdown developing method, it is particularly preferred to use resin coating carrier particles with a resin coat layer having a critical surface tension of 30 to 40 dyn/cm formed on the surface.

The reason will now be described with reference to a schematic view of the image forming unit employing a touchdown developing method shown in FIG. 5.

In FIG. 5, the developing device 50 is equipped with stirrers 33a, 33b for mixing a two-component developer T with stirring, a magnetic roller 34, and a developing roller 35 which is disposed in a state of facing the magnetic roller 34 so as to maintain contact with the magnetic roller. The developing roller 35 is disposed in a state of facing a drum-shaped photoconductor 40 while maintaining a fixed gap.

In such an image forming unit, first, the two-component developer T containing toner particles and magnetic carrier particles is stirred by stirrers 33a, 33b in a developer tank 37 and then supported on the peripheral surface of the magnetic roller 34 in the form of a magnetic brush. In this case, the thickness of the two-component developer layer is regulated by a layer thickness regulating member 36. The two-component developer layer formed on the peripheral surface of the magnetic roller 34 in the form of a magnetic brush supplies only toner particles to the developing roller 35 while the magnetic roller 34 is rotating and being brought into contact with the developing roller 35. In such a manner, a thin layer of toner particles is supported on the peripheral surface of the developing roller.35. The toner particles supported on the peripheral surface of the developing roller 35 flies toward the surface of the photoconductor 40 which is disposed in a state of facing the peripheral surface of the developing roller 35 while maintaining a fixed gap, and thus an electrostatic latent image formed on the surface of the photoconductor 40 is developed. In this developing method, by varying the voltage between the magnetic roller 34 and the developing roller 35 after toner particles fly, a toner layer on the surfaced of the developing roller 35 is once removed and a new toner layer is formed for subsequent development.

In such a touchdown developing method, it is required to apply high surface potential and strong developing electric field on the photoconductor 40 and therefore variation in the adhesion state of toner particles and potential difference arises between the consumption region and non-consumption region of toner particles on the peripheral surface of the developing roller 35, and a so-called hysteresis phenomenon in which a portion of a previous developed image appears as a ghost upon subsequent development is likely to arise.

In order to suppress the occurrence of the hysteresis phenomenon, for example, Japanese Unexamined Patent Publication (Kokai) No. 2000-298396 discloses a technique of physically removing toner particles left on the peripheral surface of a developing roller by toner removing member disposed at a downstream side of a rotation direction of the developing roller. However, according to the method disclosed in the document, the developing roller may cause wear because the toner removing member is always pressure-contacted with the peripheral surface of the developing roller. Therefore, it is not suited for application that requires durability of the apparatus.

It is also considered to suppress the occurrence of ghosting using magnetic carrier particles having a high critical surface tension so as to facilitate removal of toner particles on the developing roller by magnetic carrier particles on the magnetic roller. However, in the touchdown developing method, a toner layer is formed on the developing roller by a magnetic brush containing toner particles and magnetic carrier particles whenever each an image forming treatment is carried out and, after development, the toner particles left on the developing roller are removed by the magnetic brush and reused and thus the number of contacts between magnetic carrier particles and toner particles is noticeably larger than that in the case of using another two-component developing method. Therefore, in the case where magnetic carrier particles having a high critical surface tension are used in the touchdown developing method, when a wax or a low melting point component exists on the surface of toner particles, toner spent occurs and the charge amount of toner particles decreases, and thus toner particles are likely to scatter. Scattering of toner particles may contaminate inside of an image forming apparatus.

In the case where the two-component developer of the present embodiment is used in a touchdown developing method, when resin coating carrier particles with a resin coat layer having a critical surface tension of 30 to 40 dyn/cm formed thereon are used, toner particles on the surface of a developing roller are easily removed after development because of a comparatively high critical surface tension. Therefore, the occurrence of the hysteresis phenomenon can be more suppressed. Also, since toner particles contained in the two-component developer have a cylindrical shape, a wax and a melting point material are less likely to be exposed on the surface of the toner particles. Therefore, even when a resin coat layer of magnetic carrier particles has a comparatively high critical surface tension, toner spent is less likely to occur. Consequently, the occurrence of the scattering of toner particles can be prevented, and thus high image stability can be realized.

In the case where the critical surface tension of the resin coat layer is less than 30 dyn/cm, it becomes difficult to remove toner particles on the surface of a developing roller after development when used in a touchdown developing method and the amount of the residual toner particles increases, and thus the hysteresis phenomenon may be more likely to occur. In contrast, when the critical surface tension is more than 40 dyn/cm, in a touchdown developing method in which the number of contact between magnetic carrier particles and toner particles is large, toner spent is likely to occur because toner particles are likely to adhere to magnetic carrier particles. Therefore the charge amount of toner particles decreases, scattering of the toner particles is likely to occur.

Critical surface tension is a value inherent to a resin which constitutes a resin coat layer. The critical surface tension (dyn/cm) is determined by the following procedure. That is, a resin coated on carrier particles to be measured is applied on a flat plate and then the coated flat plate is treated under the same conditions as in the production of magnetic carrier particles to form a resin coating film. On the resin coating film thus obtained as a test piece, each contact angle of pure water, methylene iodide and α-bromonaphthalene is measured, and thus the critical surface tension can be calculated by a Zisman method based on the measurement results of the contact angle.

The critical surface tension of the resin coat layer can be easily adjusted by mixing two or more kinds of resins constituting the resin coat layer in a predetermined ratio.

The two-component developer of the present embodiment can be obtained by mixing with the toner particles and the magnetic carrier particles in a proper ratio. The ratio of the magnetic carrier particles to the toner particles may be the same as that of a conventional two-component developer and there are no restrictions on the ratio. The two-component developer of the present embodiment can be used in an image forming apparatus such as an electrostatic copying machine or a laser beam printer.

### EXAMPLES

The present invention will now be described by way of examples, but the present invention is not limited to the following examples.

### Examples 1 to 2 and Comparative Example 1 to 3

### (Preparation of Binder Resin)

In a reaction vessel equipped with a thermometer, a stirrer, a nitrogen introducing tube and a refluxing tube, 300 parts by mass of xylene was charged. While maintaining a liquid temperature to 170° C. by heating the reaction vessel and continuously introducing nitrogen through the nitrogen introducing tube, a solution prepared by dissolving 845 parts by mass of styrene, 155 parts by mass of n-butyl acrylate and 8.5 parts by mass of di-tert-butyl peroxide in 125 parts by mass of xylene was added dropwise in the reaction vessel over 3 hours while stirring. After the completion of dropwise addition, stirring was continued for one hour at 170° C. The solution was dried to remove the solvent, and thus a binder resin made of a styrene-n-butyl acrylate copolymer was obtained.

### (Production of Cylindrical Toner Particles)

Using 92 parts by mass of the resulting binder resin, 5 parts by mass of a colorant (carbon black: MA-100 manufactured by Mitsubishi Chemical Corporation), 3 parts by mass of a charge control agent (N-01 manufactured by Orient Chemical Industries, Ltd.) and 3 parts by mass of a releasant (polyethylene wax: 110P manufactured by Mitsui Chemical Co.) as toner materials, cylindrical toner particles were produced by the above-mentioned production method using the apparatuses as shown in FIG. 3 and FIG. 4.

Any cylindrical diameter D of the resulting cylindrical toner /particles was about 5 μm, while the cylindrical length L was 8 μm. The cylindrical length L was adjusted by adjusting the rotary speed of the rotary knife 10 of the cutting device 8. At this time, L/D of the cylindrical toner particles was 1.6.

L/D was determined by the following procedure. Namely, an image at 2,000 times magnification of the cylindrical toner particles was taken under a scanning electron microscope (SEM). At this time, 100 cylindrical toner particles were sampled at random from the image and then the cylindrical length L and the cylindrical diameter D of the respective cylindrical toner particles were measured. Then, the averages of the cylindrical length L and of the cylindrical diameter D were determined. On the basis of the resulting averages, a value obtained by dividing the cylindrical length L of cylindrical toner particles in the respective cylindrical toner particles by the cylindrical diameter D, L/D, was calculated. In the case where the cut surface does not intersect perpendicularly to the central axis of the cylindrical toner (in the case where the cut surface is inclined or curved), the axis length of the central axis is referred to as the cylindrical length L.

To 100 part by mass of the cylindrical toner particles thus obtained, 1.0 parts by mass of silica: RA-200H (manufactured by Nippon Aerosil Co., Ltd.) as an external additive was added, followed by mixing using a Henschel mixer (manufactured by Mitsui Mining Co., Ltd.).

### Example 1

The resulting cylindrical toner particles were mixed with a ferrite carrier (average particle size: 80 μm) having an average sphericity of 0.95 in a ratio of toner particles to ferrite carrier particles of 1:19 to prepare a black two-component developer.

The average sphericity was determined by the following procedure. Using a flow-type particles image analyzer (FPIA-2100 manufactured by Sysmex Corporation), shape measurement was performed and sphericity (a) of the measured particles was determined by the following equation (1):

a=L₀/L (1)

where L₀ denotes the peripheral length of a circle having the same projection area as that of a projection image of particles, and L denotes the peripheral length of a projection image of particles. Then, the sum total of sphericity of the entire measured particles was divided by the number of particles to obtain the average sphericity.

Using the resulting two-component developer, the following properties were evaluated.

Evaluation of Properties

Using a copying machine (copying machine obtained by modifying a copying machine “KM-5530” manufactured by KYOCERA MITA Corporation) employing a two-component developing device in which the resulting two-component developer is filled in a developing device, an image was formed based on an original copy having an original copy density of 4%. The image was formed under a normal temperature and a normal humidity environment at a temperature of 20° C. and a humidity of 65%, and then properties were evaluated by the following methods.

(i) Image Density

Image density was evaluated so as to confirm the effect of improving image stability. Using a reflection densitometer (TC-6D manufactured by Tokyo Denshoku Co., Ltd.), the image density at three portions (images at both sides and center) corresponding to a black solid portion of one copied image was measured and the average of the measured image densities was employed as the image density of the formed image. Evaluation was performed according to the following criteria. Namely, the case where the image density is 1.30 or more was rated as “Good”, whereas, the case where the image density is less than 1.30 was rated as “Poor”.

(ii) Fog Density

Fog density was evaluated so as to confirm the effect of improving cleaning properties. Using a reflection densitometer (TC-6D manufactured by Tokyo Denshoku Co., Ltd.), the image density of blank potion at three portions (lower portions of the above black solid portion) of one copied image was measured and the average of the measured image densities was employed as the fog density of the formed image. Evaluation was performed according to the following criteria. Namely, the case where the fog density is 0.003 or less was rated as “Good”, whereas, the case where the fog density is more than 0.003 was rated as “Poor”.

(iii) Spent Amount (Amount of Toner Component Adhered onto Magnetic Carrier due to Spent Phenomenon)

The amount of the toner component adhered onto the recovered magnetic carrier particles was measured by the following method.

The two-component developer thus recovered was placed on a 400 mesh sieve and then separated into toner particles and magnetic carrier particles by sucking from below using a suction apparatus.

Then, 5 g of magnetic carrier particles left on the sieve was put in toluene in a beaker, thereby dissolving the toner component adhered onto the surface of magnetic carrier particles. Then, the toluene solution was removed in a state where magnetic carriers are magnetically attracted from under the beaker. After repeating this operation several times until the toluene becomes colorless, the mass of the residue in the beaker left after vaporization of the toluene in an oven was measured. The difference between the mass of magnetic carrier particles charged in the beaker at first and the mass of the residue left after vaporization of the toluene in the beaker is the amount (spent amount) of the toner component adhered onto the surface of the magnetic carrier particles. The spent amount is expressed by the mass (mg) of the toner component adhered based on 1 g of the magnetic carrier particles as a result of being spent. The case where the spent amount is 0.3 mg or less was rated as “Good”, whereas, the case where the spent amount is more than 0.3 mg was rated as “Poor”.

The respective properties were evaluated at the initiation of an image forming treatment (0 sheets), and at each timing after continuous printing of 20,000 sheets, 40,000 sheets, 60,000 sheets and 80,000 sheets. The spent amount was not measured at the initiation of the image forming treatment (0 sheets). As used herein, continuous printing means printing in which an image is continuously formed.

The results are shown in Table 1.

### Example 2

In the same manner as in Example 1, except that a resin carrier (average particle size: 80 μm) having an average sphericity of 0.96 was used in place of the ferrite carrier having an average sphericity of 0.95, a black two-component developer was prepared. Then, properties were evaluated in the same manner as in Example 1. The results are shown in Table 1.

### Comparative Example 1

In the same manner as in Example 1, except that toner particles having an average sphericity of 0.92 obtained by a grinding method were used in place of cylindrical toner particles, a black two-component developer was prepared. Then, properties were evaluated in the same manner as in Example 1. The results are shown in Table 1.

### Comparative Example 2

In the same manner as in Example 1, except that toner particles having an average sphericity of 0.98 obtained by a suspension polymerization method were used in place of cylindrical toner particles, a black two-component developer was prepared. Then, properties were evaluated in the same manner as in Example 1. The results are shown in Table 1.

### Comparative Example 3

In the same manner as in Example 1, except that a ferrite carrier (average particle size: 80 μm) having an average sphericity of 0.94 was used in place of the ferrite carrier having an average sphericity of 0.95, a black two-component developer was prepared. Then, properties were evaluated in the same manner as in Example 1. The results are shown in Table 1.

TABLE 1

| | | 0 SHEETS | 20,000 SHEETS | 40,000 SHEETS | 60,000 SHEETS | 80,000 SHEETS |
|---|---|---|---|---|---|---|
| EXAMPLE 1 | IMAGE DENSITY | 1.38 | 1.38 | 1.36 | 1.34 | 1.36 |
| | FOG DENSITY | 0.001 | 0.003 | 0.002 | 0.001 | 0.001 |
| | SPENT AMOUNT | | 0.10 | 0.13 | 0.16 | 0.18 |
| EXAMPLE 2 | IMAGE DENSITY | 1.36 | 1.36 | 1.38 | 1.38 | 1.37 |
| | FOG DENSITY | 0.002 | 0.003 | 0.002 | 0.003 | 0.003 |
| | SPENT AMOUNT | | 0.10 | 0.12 | 0.15 | 0.16 |
| COMPARATIVE | IMAGE DENSITY | 1.36 | 1.40 | 1.44 | 1.48 | |
| EXAMPLE 1 | | | | | | |
| | FOG DENSITY | 0.002 | 0.005 | 0.012 | 0.026 | |
| | SPENT AMOUNT | | 0.15 | 0.32 | 0.50 | |
| COMPARATIVE | IMAGE DENSITY | 1.37 | 1.37 | | | |
| EXAMPLE 2 | | | | | | |
| | FOG DENSITY | 0.002 | 0.030 | | | |
| | SPENT AMOUNT | | 0.14 | | | |
| COMPARATIVE | IMAGE DENSITY | 1.37 | 1.38 | 1.40 | 1.43 | 1.46 |
| EXAMPLE 3 | | | | | | |
| | FOG DENSITY | 0.002 | 0.003 | 0.006 | 0.010 | 0.018 |
| | SPENT AMOUNT | | 0.16 | 0.22 | 0.36 | 0.49 |

In Example 1 and Example 2, in which a two-component developer prepared by mixing cylindrical toner particles with magnetic carrier particles having an average sphericity of 0.95 or more was used, all of the image density, the fog density and the spent amount were rated as “Good” at any time of printing 0 to 80,000 sheets.

In Comparative Example 1, in which a two-component developer prepared by mixing toner particles obtained by a grinding method with magnetic carrier particles having an average sphericity of 0.95 or more was used, the fog density was rated as “Poor” at the time of printing 20,000 sheets. Since scattering of toner particles also occurred at the time of printing 60,000 sheets, the test was terminated. In Comparative Example 2, in which a two-component developer prepared by mixing toner particles obtained by a suspension polymerization method with magnetic carrier particles having an average sphericity of 0.95 or more was used, the fog density was rated as “Poor” at the time of printing 20,000 sheets and the test was terminated.

In Comparative Example 3, in which a two-component developer prepared by mixing cylindrical toner particles with magnetic carrier particles (average particle size: 80 μm) having an average sphericity of 0.94 was used, the fog density was rated as “Poor” at the time of printing 40,000 sheets and the spent amount became 0.36 mg at the time of printing 60,000 sheets, and thus it was rated as “Poor”.

As is apparent from the test results shown in Table 1, a two-component developer containing cylindrical toner particles and a magnetic carrier made of a spherical carrier having an average sphericity of 0.95 or more is excellent in image quality (image density, fog density) after printing and also can suppress the occurrence of the spent phenomenon.

### Examples 3 to 13

In the following Examples described below, a two-component developer containing cylindrical toner particles and magnetic carrier particles with a resin coat layer having a predetermined critical surface tension formed thereon is used in a copying machine employing a touchdown developing method.

First, the method for producing cylindrical toner particles used in these Examples and the resin for formation of the coat layer used to form a resin coat layer will be described.

### (Production of Cylindrical Toner Particles)

In the same manner as in Example 1, except that cylindrical toner particles measuring 5 μm in diameter and 7 μm in length were used, cylindrical toner particles were obtained.

Separately, silica (RA-200H manufactured by Nippon Aerosil Co., Ltd.) was crushed using a jet mill (Model IDS-2 manufactured by Nippon Pneumatic Mfg. Co., Ltd.) to obtain fine silica particles. 100 parts by mass of the resulting fine silica particles were placed in a closed type Henschel mixer and 20 parts by mass of a hydrophobized treating agent obtained by mixing γ-aminopropyltriethoxysilane and dimethylsilicone oil in an equal amount was uniformly sprayed over the fine silica particles, and then a hydrophobization treatment was performed by reacting at 110° C. for 2 hours while mixing with stirring. Then, the reaction product was heated at 200° C. for one hour while removing the side reaction product under reduced pressure to obtain hydrophobic fine silica particles.

To the cylindrical toner particles, 1.0 parts by mass of the hydrophobic fine silica particles and 0.5 parts by mass of titanium oxide (EC-100T1J (manufactured by Titan Kogyo Kabushiki Kaisha) were added, followed by mixing with stirring for 4 minutes in a Henschel mixer.

### <Resin for Formation of Coat Layer>

Four kinds of resins A to D, each having a critical surface tension as shown in Table 2, were used alone or in combination as a resin for formation of a coat layer.

TABLE 2

| | | CRITICAL SURFACE |
|---|---|---|
| | KIND OF RESIN | TENSION (dyn/cm) |
| RESIN A | SILICONE RESIN | 14 |
| RESIN B | FLUORORESIN | 18 |
| RESIN C | EPOXY RESIN | 45 |
| RESIN D | ACRYL RESIN | 48 |

### Example 3

A coating solution was prepared by dissolving 15 parts by mass of the fluororesin and 15 parts by mass of the epoxy resin in 200 parts by mass of toluene. Using a fluidized bed coating device, the coating solution was spray-coated on 1,000 parts by mass of a Cu—Zn ferrite core material and a heat treatment was performed at 250° C. for 60 minutes to obtain magnetic carrier particles having an average sphericity of 0.95, an average particle size of 50 μm and a resin coat layer having a critical surface tension of 33 dyn/cm. Then, the cylindrical toner particles were mixed with the resulting magnetic carrier particles in a mixing ratio of 1:10, followed by mixing with stirring in a ball mill to obtain a two-component developer. Using the resulting two-component developer, the following properties were evaluated.

### (Evaluation of Properties)

Using a copying machine (color page printer “FS-C5016N” manufactured by KYOCERA MITA Corporation) employing a touchdown developing method, and the resulting two-component developer, an image was formed based on an original copy having an original copy density of 5% under a normal temperature and a normal humidity environment at a temperature of 20° C. and a humidity of 60%, and then properties were evaluated by the following methods.

(i) Hysteresis Phenomenon

A copied image was visually observed, and it was confirmed whether or not a hysteresis phenomenon and ghosting occurred.

(ii) Toner Particle Scatter

After continuously printing 100,000 sheets, it was confirmed whether or not scattering of toner particles occurred in the apparatus.

The results are shown in Table 3.

### Example 4

In the same manner as in Example 3, except that a coating solution prepared by dissolving 6 parts by mass of a fluororesin and 24 parts by mass of the epoxy resin in 200 parts by mass of toluene was used in place of the coating solution used in Example 3, magnetic carrier particles having an average sphericity of 0.95, an average particle size of 50 μm and a resin coat layer having a critical surface tension of 39.5 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 5

In the same manner as in Example 3, except that a coating solution prepared by dissolving 12 parts by mass of the fluororesin and 18 parts by mass of the epoxy resin in 200 parts by mass of toluene was used in place of the coating solution used in Example 3, magnetic carrier particles having an average sphericity of 0.95, an average particle size of 50 μm and a resin coat layer having a critical surface tension of 34.2 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 6

In the same manner as in Example 3, except that a coating solution prepared by dissolving 18 parts by mass of the fluororesin and 12 parts by mass of the acrylic resin in 200 parts by mass of toluene was used in place of the coating solution used in Example 3, magnetic carrier particles having an average sphericity of 0.95, an average particle size of 50 μm and a resin coat layer having a critical surface tension of 30.3 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 7

In the same manner as in Example 3, except that a coating solution prepared by dissolving 9 parts by mass of the fluororesin and 21 parts by mass of the acrylic resin in 200 parts by mass of toluene was used in place of the coating solution used in Example 3, magnetic carrier particles having an average sphericity of 0.95, an average particle size of 50 μm and a resin coat layer having a critical surface tension of 37 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 8

In the same manner as in Example 3, except that a coating solution prepared by dissolving 30 parts by mass of the silicone resin in 200 parts by mass of toluene was used in place of the coating solution used in Example 3, magnetic carrier particles having an average sphericity of 0.96, an average particle size of 50 μm and a resin coat layer having a critical surface tension of 14 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 9

In the same manner as in Example 3, except that a coating solution prepared by dissolving 30 parts by mass of the fluororesin in 200 parts by mass of toluene was used in place of the coating solution used in Example 3, magnetic carrier particles having an average sphericity of 0.96, an average particle size of 50 μm and a resin coat layer having a critical surface tension of 18 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 10

In the same manner as in Example 3, except that a coating solution prepared by dissolving 30 parts by mass of the epoxy resin in 200 parts by mass of toluene was used in place of the coating solution used in Example 3, magnetic carrier particles having an average sphericity of 0.96, an average particle size of 50 μm and a resin coat layer having a critical surface tension of 45 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 11

In the same manner as in Example 3, except that a coating solution prepared by dissolving 30 parts by mass of the acrylic resin in 200 parts by mass of toluene was used in place of the coating solution used in Example 3, magnetic carrier particles having an average sphericity of 0.96, an average particle size of 50 μm and a resin coat layer having a critical surface tension of 48 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 12

In the same manner as in Example 3, except that a coating solution prepared by dissolving 18 parts by mass of the fluororesin and 12 parts by mass of the epoxy resin in 200 parts by mass of toluene was used in place of the coating solution used in Example 3, magnetic carrier particles having an average sphericity of 0.95, an average particle size of 50 μm and a resin coat layer having a critical surface tension of 27 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

### Example 13

In the same manner as in Example 3, except that a coating solution prepared by dissolving 6 parts by mass of the fluororesin and 24 parts by mass of the acrylic resin in 200 parts by mass of toluene was used in place of the coating solution used in Example 3, magnetic carrier particles having an average sphericity of 0.95, an average particle size of 50 μm and a resin coat layer having a critical surface tension of 44 dyn/cm, were obtained. Then, the cylindrical toner particles were mixed with the resulting magnetic carrier particles in a mixing ratio of 1:10, followed by mixing with stirring in a ball mill to obtain a two-component developer. In the same manner as in Example 3, properties were evaluated. The results are shown in Table 3.

TABLE 3

| | | | CRITICAL | | |
|---|---|---|---|---|---|
| | | | SURFACE | HYSTERESIS | TONER |
| | KIND OF RESIN | RATIO | TENSION | PHENOMENON | SCATTER |
| EXAMPLE 3 | B/C | 5/5 | 33 | NOT OCCURRED | NOT OCCURRED |
| EXAMPLE 4 | B/C | 2/8 | 39.5 | NOT OCCURRED | NOT OCCURRED |
| EXAMPLE 5 | B/C | 4/6 | 34.2 | NOT OCCURRED | NOT OCCURRED |
| EXAMPLE 6 | B/D | 6/4 | 30.3 | NOT OCCURRED | NOT OCCURRED |
| EXAMPLE 7 | B/D | 3/7 | 37 | NOT OCCURRED | NOT OCCURRED |
| EXAMPLE 8 | A | 10 | 14 | OCCURRED | NOT OCCURRED |
| EXAMPLE 9 | B | 10 | 18 | OCCURRED | NOT OCCURRED |
| EXAMPLE 10 | C | 10 | 45 | NOT OCCURRED | OCCURRED |
| EXAMPLE 11 | D | 10 | 48 | NOT OCCURRED | OCCURRED |
| EXAMPLE 12 | B/C | 6/4 | 27 | OCCURRED | NOT OCCURRED |
| EXAMPLE 13 | B/D | 2/8 | 44 | NOT OCCURRED | OCCURRED |

When using the two-component developers of Examples 3 to 7, which contain cylindrical toner particles and magnetic carrier particles having an average sphericity of 0.95 or more and having a resin coat layer having a critical surface tension of 30 to 40 dyn/cm formed on the surface thereof, the hysteresis phenomenon did not occur and also toner particles did not scatter.

When using the two-component developers of Examples 8, 9 and 12 in which the resin coat layer of magnetic carrier particles has a critical surface tension of less than 30 dyn/cm, the hysteresis phenomenon was observed. When using the two-component developers of Examples 10, 11 and 13 in which the resin coat layer of magnetic carrier particles has a critical surface tension of more than 40 dyn/cm, scattering of toner particles was observed. As is apparent from the results described above, the occurrence of the hysteresis phenomenon and scattering of toner particles can be more suppressed by using magnetic carrier particles having a resin coat layer having a critical surface tension of 30 to 40 dyn/cm.

One aspect described in detail above of the present invention pertains to a two-component developer comprising cylindrical toner particles, and magnetic carrier particles having an average sphericity of 0.95 or more. When such a two-component developer is used, a clear image can be stably obtained for a long period by suppressing a spent phenomenon and insufficiency cleaning.

Also, the magnetic carrier particles preferably have a resin coat layer having a critical surface tension of 30 to 40 dyn/cm on the surface of the particles. When such a two-component developer is used, a spent phenomenon can be more suppressed. Particularly, when a touchdown developing method is employed, the occurrence of a hysteresis phenomenon upon printing and scattering of toner particles in an image forming apparatus upon continuous printing can be suppressed.

Also, the ratio of the cylindrical length (L) to the cylindrical diameter (D) of the cylindrical toner particles, (L/D), is preferably from 1 to 2. When such a two-component developer is used, the two-component developer is excellent in compatibility with a carrier and is less likely to adhere onto the surface of carrier particles. When L/D is less than 1, the proportion of a cut surface of the toner in which a comparatively large amount of the wax is exposed is large. Therefore, the toner is likely to adhere onto the carrier because the cut surface is often brought into contact with the carrier. In contrast, when L/D is more than 2, the cylindrical shape is converted into a rectangular shape, and thus fluidity deteriorates and also becomes difficult to separate from the surface of the carrier.

Also, the cylindrical toner particles have preferably a cylindrical diameter (D) within a range from 5 to 10 μm because adhesion onto the carrier can be suppressed effectively.

Also, the cylindrical toner particles are preferably obtained by cutting a fiber formed of a molten toner material because it is possible to make the particle size uniform.

Also, the cylindrical toner particles preferably contain hydrophobic fine silica particles added externally thereto because proper fluidity is secured and stable friction charging is performed.

Also, the cylindrical toner particles preferably contains, as a binder resin, a polystyrene-based resin having a molecular weight distribution which has at least two peaks, a peak within a range from 3,000 to 20,000 and a peak within a range from 300,000 to 1,500,000 and 10 or more of Mw/Mn (mass average molecular weight/number average molecular weight) because toner particles having excellent fixability and anti-offset properties are obtained.

Also, the cylindrical toner particles preferably contain a binder resin having a glass transition point (Tg) within a range from 50 to 70° C. because the resulting two-component developer is excellent in fixability and storage stability of the toner.

Also, another embodiment of the present invention pertains to a developing device which is mounted in an image forming apparatus of a two-component developing method, comprising a developer tank equipped with a stirrer, which encases the two-component developer, a developing roller capable of supporting the two-component developer encased in the developer tank on the peripheral surface of the developing roller through rotation around a roller axis, and a layer thickness regulating member which is provided on the peripheral surface of the developing roller so as to contact with the developing roller, and regulates the thickness of the supported two-component developer and charges the toner particles supported on the peripheral surface of the developing roller.

Also, another embodiment of the present invention pertains to an image forming apparatus of a two-component developing method, comprising: a photoconductor drum, and a charger for charging the photoconductor drum, an exposure device for exposing the surface of the photoconductor drum charged with the charger to form an electrostatic latent image, the developing device for supplying a toner in the two-component developer onto the surface of the photoconductor drum on which the electrostatic latent image is formed, a transfer device for transferring the toner image onto a paper, and a removing device for removing the toner left on the surface of the photoconductor drum after transferring the toner image onto the paper being sequentially arranged along a rotation direction of the photoconductor drum, the developing device being arranged so that a peripheral surface of the developing roller and a peripheral surface of the photoconductor drum are disposed in a state of facing each other.

Also, another embodiment of the present invention pertains to an image forming apparatus of a touchdown developing method, comprising a developer tank equipped with a stirrer, which encases the two-component developer, a magnetic roller capable of supporting the two-component developer encased in the developer tank on the peripheral surface of the magnetic roller in the form of a magnetic brush, a developing roller capable of supporting cylindrical toner particles in the two-component developer on the peripheral surface of the developing roller through contact with the two-component developer supported on the magnetic roller, and a photoconductor drum which is disposed in a state of facing the peripheral surface of the developing roller while maintaining a fixed gap, an electrostatic latent image of a predetermined image being formed on the surface of the photoconductor drum through exposure, wherein the electrostatic latent image is developed by allowing the cylindrical toner particles supported on the peripheral surface of the developing roller fly onto the surface of the photoconductor drum.

This application is based on patent application Nos. 2006-324342 and 2007-130738 filed in Japan, the contents of which are hereby incorporated by references.

Although the present invention has been fully described by way of example, it is to be understood that various changes and modifications will be apparent to those skilled in the art. Therefore, unless otherwise such changes and modifications depart from the scope of the present invention hereinafter defined, they should be construed as being included therein.

What is claimed is:

1. A two-component developer comprising:
cylindrical toner particles, and magnetic carrier particles having an average sphericity of 0.95 or more.

2. The two-component developer according to claim 1, wherein the magnetic carrier particles have a resin coat layer having a critical surface tension of 30 to 40 dyn/cm on the surface of the particles.

3. The two-component developer according to claim 1, wherein a ratio of a cylindrical length (L) to a cylindrical diameter (D) of the cylindrical toner particles, (L/D), is from 1 to 2.

4. The two-component developer according to claim 1, wherein the cylindrical toner particles have a cylindrical diameter (D) within a range from 5 to 10 μm.

5. The two-component developer according to claim 1, wherein the cylindrical toner particles are obtained by cutting a fiber formed of a toner material.

6. The two-component developer according to claim 1, wherein the cylindrical toner particles contain hydrophobic fine silica particles added externally thereto.

7. The two-component developer according to claim 1, wherein the cylindrical toner particles contain, as a binder resin, a polystyrene-based resin having a molecular weight distribution which has at least two peaks, a peak within a range from 3,000 to 20,000 and a peak within a range from 300,000 to 1,500,000 and 10 or more of Mw/Mn (mass average molecular weight/number average molecular weight).

8. The two-component developer according to claim 1, wherein the cylindrical toner particles contain a binder resin having a glass transition point (Tg) within a range from 50 to 70° C.

9. A developing device which is mounted in an image forming apparatus of a two-component developing method, comprising:
a developer tank equipped with a stirrer, which encases the two-component developer according to claim 1,
a developing roller capable of supporting the two-component developer encased in the developer tank on a peripheral surface of the developing roller through rotation around a roller axis, and
a layer thickness regulating member which is provided on the peripheral surface of the developing roller so as to contact with the developing roller, and regulates a thickness of the supported two-component developer and charges the toner particles supported on the peripheral surface of the developing roller

10. An image forming apparatus of a two-component developing method, comprising:
a photoconductor drum, and a charger for charging the photoconductor drum, an exposure device for exposing the surface of the photoconductor drum charged with the charger to form an electrostatic latent image, the developing device according to claim 9 for supplying a toner in the two-component developer onto the surface of the photoconductor drum on which the electrostatic latent image is formed, a transfer device for transferring the toner image onto a paper, and a removing device for removing the toner left on the surface of the photoconductor drum after transferring the toner image onto the paper being sequentially arranged along a rotation direction of the photoconductor drum, the developing device being arranged so that a peripheral surface of the developing roller and a peripheral surface of the photoconductor drum are disposed in a state of facing each other.

11. An image forming apparatus of a touchdown development method, comprising:
a developer tank equipped with a stirrer, which encases the two-component developer according to claim 2,
a magnetic roller capable of supporting the two-component developer encased in the developer tank on a peripheral surface of the magnetic roller in the form of a magnetic brush,
a developing roller capable of supporting cylindrical toner particles in the two-component developer on a peripheral surface of the developing roller through contact with the two-component developer supported on the magnetic roller, and
a photoconductor drum which is disposed in a state of facing the peripheral surface of the developing roller while maintaining a fixed gap, an electrostatic latent image of a predetermined image being formed on a surface of the photoconductor drum through exposure, wherein
the electrostatic latent image is developed by allowing the cylindrical toner particles supported on the peripheral surface of the developing roller fly onto the surface of the photoconductor drum.
